(19) United States
(12) Patent Application Publication
(10) Pub. No.: US 2012/0013103 A1
(43) Pub. Date: Jan. 19, 2012

(54) QUICK-LOCK MOTORCYCLE FOLD-UP STRUCTURE

(75) Inventor: Fabrice Marion, Paris (FR)

(73) Assignee: XOR.MOTORS, Meyreuil (FR)

(21) Appl. No.: 13/141,911

(22) PCT Filed: Dec. 11, 2009
(86) PCT No.: PCT/FR2009/052497

§ 371 Date: Oct. 7, 2011

(30) Foreign Application Priority Data
Dec. 23, 2008 (FR) 08 59042

(51) Int. Cl. B62B 3/02

(52) U.S. Cl. 280/639

(57) ABSTRACT

The invention relates to a motorcycle vehicle comprising a chassis which is open at its middle and supports at least one seat tube for supporting a saddle, on which chassis a pivoting arm supporting a rear wheel is mounted, about an axis of rotation, characterized in that the assembly consisting of the pivoting arm and the rear wheel is free to pivot towards the front of vehicle and towards the bottom of the vehicle about its axis of rotation so that it can be housed in the opening in the chassis. Advantageously, the seat tube is also articulated so that it can be rotated forwards and preferably allows the cycle to be locked in a folded position.

### BACKGROUND OF THE INVENTION

The present invention relates to the general field of foldable cycles and more particularly that of foldable motorcycle vehicles and mopeds.

There are currently numerous cycle folding systems. These systems are suited to an implementation on light-weight cycles that do not include motor drive or fairings.

Now, the bulk and robustness constraints are very different from the moment when the vehicle has a motor drive and, possibly, a fairing.

The invention seeks to allow for a compact folding/unfolding of a motorized vehicle of scooter or motorcycle type, the implementation of which is extremely simple for the user.

### OBJECT AND SUMMARY OF THE INVENTION

The object of the present invention is to produce a motorcycle vehicle comprising a frame open in its middle and supporting at least one saddle-supporting upright to support a saddle, on which frame is mounted, about an axis of rotation, a pivoting arm supporting a rear wheel, characterized in that the pivoting arm/rear wheel assembly is free to pivot toward the front of the vehicle and via the bottom of the vehicle about its axis of rotation so that it can be housed in the opening in the frame.

According to the invention, the pivoting arm has a movement that is performed by rotation by passing under the frame until the pivoting arm/rear wheel assembly is positioned, no longer toward the rear in extension of the frame, but toward the front, inside the latter.

By passing underneath, the rear wheel can rest on the ground and roll, which is an advantage if it is heavy, for example when it includes a hub motor.

Such a motorcycle vehicle thus offers the possibility of having its overall length drastically reduced when it is folded-up. In practice, according to the invention, the reduction length of the motorcycle vehicle corresponds to the overall length reduced to the horizontal of the pivoting arm/rear wheel assembly, also hereinafter called rear end.

The invention makes it possible to fold up motorized vehicles which usually have fairings and which therefore have specific volume and configuration constraints when it comes to the very design of the frame.

The fact of having a frame that is open in its middle and of housing the rear end consisting of the pivoting arm and the rear wheel therein, is a quite original feature of the invention.

Advantageously, the pivoting arm/rear wheel assembly is free to pivot toward the front of the vehicle and via the bottom over an angle greater than 180°.

With such a characteristic, a maximum extension of the pivoting arm/rear wheel assembly toward the rear is provided, when said assembly is unfolded, as is a maximum folding up of this assembly into the open frame when it is folded up. This makes it possible to address the particular need of motorized vehicles to have a wheelbase that is as great as possible.

In an advantageous embodiment, the frame comprises a double cradle whose branches are connected to the steering tube vertically or obliquely, each of these branches also being connected to a lateral bar, the space between the branches of the double cradle and the lateral bars defining the internal opening of the frame.

This embodiment allows for the pivoting arm to be elongated without elongating the length of the frame reduced to the horizontal. As it happens, the rear wheel can then pass, when the pivoting arm is folded-up, between the branches of the double cradle. The point at which these branches meet close to the steering tube is, in effect, higher than the lateral bars which constitute a part of the floor and which support the pivoting arm. The distance to be taken into account for the movement of the pivoting arm relative to the frame is then the diagonal between this point and the axis of rotation of the pivoting arm which is of a length greater than the length of the opening related to the horizontal.

According to an advantageous characteristic, the maximum length of the internal opening of the frame and the pivoting arm/rear wheel assembly have similar lengths.

According to this characteristic, the pivoting arm is as long as the internal length of the frame even a little longer. Thus, when folding up, the wheel touches the front internal face of the frame, even passes under force by rolling over the front internal face of the frame. This similarity in the lengths of the opening of the frame and of the pivoting arm/rear wheel assembly ensures a maximum compactness of the motorcycle vehicle once the latter is folded up. Obviously, preferentially, the external length of the frame is then close to that of the opening. A maximum compactness is then assured once the vehicle is folded up. The expressions “close” or “similar” lengths should be understood to mean lengths which make it possible for one or other of the two elements not to exceed, by a distance greater than 10%, and preferentially 5%, the overall length of one element relative to the other element, these lengths being related to the horizontal plane.

This corresponds to one of the objects of the invention, namely to produce a motorcycle vehicle, with two or three wheels, with a motor of scooter or motorcycle type, which can be folded up, for which the deployed dimensions/folded-up dimensions ratio, in particular the length, is as great as possible.

It is in fact desirable for road travel for the vehicle to be as long as possible in the deployed position, or approximately 170 cm to achieve the dimension of a scooter, but also for the vehicle to have a highly reduced bulk in the folded-up position, or the size of a suitcase, that is to say, a length of approximately 90 cm.

The major interest is in reconciling two conflicting needs: the maximum deployed length which confers its wheelbase on the vehicle and therefore its stability from a certain speed, and the minimum bulk in the folded-up configuration.

The invention therefore makes it possible, while benefitting from a genuine scooter, to make its general use easier, particularly in an urban context, because it facilitates the storage, the securing or the trans-portation thereof. It is in fact possible to envisage storing the motorcycle vehicle directly in an apartment to avoid theft, deterioration and bad weather.

It is also possible to envisage taking it along as an extension for another mode of transport, whether it be passenger car transport or public transport.

New and additional uses compared to the conventional motorized two wheels are therefore achieved by virtue of the possibility of transportation and storage which allows for more numerous use situations.

It should be noted here that it will be advantageous for the motor drive to be as compact as possible on a vehicle according to the invention. It will also be necessary for the motor drive to be compatible with manipulations in various positions. It is therefore desirable for the motor drive to avoid fluids. The use of an electric motor inserted in the hub of the wheel and powered by a battery is therefore the best solution, and the one more particularly targeted by the invention.

Advantageously, the entire motorized vehicle described according to the invention will be produced in a light-weight material so as to facilitate handling and portability.

According to a preferential characteristic of the invention, the saddle-supporting upright is articulated about an axis of rotation which is situated close to or is the same as the axis of rotation of the pivoting arm, this saddle-supporting upright being able to tilt toward the front of the vehicle and via the top of the cycle so as to join, above the frame of the cycle, the pivoting arm/rear wheel assembly when the latter is pivoted toward the front of the vehicle.

The invention thus ensures the folding up of the pivoting arm supporting the rear wheel by longitudinal pivoting toward the front and of the saddle by tilting toward the front and intersecting the rear end. This feature makes it possible to give the motorized vehicle an even greater compactness by making it possible to displace the saddle toward the front during a tilting movement via the top of the cycle. It will be understood that this tilting is performed in the direction opposite to the pivoting of the pivoting arm/rear wheel assembly.

Allowance is thus made for the two elements representing the greatest bulk on the rear of the vehicle, namely the pivoting arm and the saddle block, to be brought together toward the front of the vehicle by virtue of two substantially symmetrical movements either side of the frame of the cycle. These symmetrical movements make it possible for these two elements to be attached to one another on the front of the vehicle at the level of the frame.

According to an advantageous characteristic, the maximum length of the internal opening of the frame, the pivoting arm/rear wheel assembly and the saddle-supporting upright have similar lengths.

This feature of the lengths being almost identical makes it possible to ensure a maximum compactness since none of the frame, pivoting arm/rear wheel and saddle-supporting upright elements will substantially exceed the other two once the cycle is folded up. Such exceeding would adversely affect the compactness of the folded up vehicle.

According to a particularly advantageous characteristic of the invention, the saddle tilted toward the front makes it possible to lock the pivoting arm/rear wheel assembly in position.

The tilting of the saddle toward the front makes it possible not only to ensure a compactness of the folded-up vehicle but also to prevent any inopportune unfolding of the pivoting arm once the latter is pivoted to the front. The tilting of the saddle thus takes on an important functional role. This feature is therefore particularly significant inasmuch as the motorcycle vehicle is intended to be able to be lifted, for example to placed in the trunk of a car. The simple and non-bulky locking of the folded cycle is therefore a crucial issue. The saddle and the pivoting arm may, for this, support elements for attaching the pivoting arm to the saddle.

For the principle of compactness, according to an advantageous characteristic, the saddle-supporting upright is such that the pivoting arm/rear wheel assembly pivoted toward the front is accommodated under the saddle.

It will be noted that this characteristic can be used to lock the pivoting arm/rear wheel assembly in position by immobilizing this assembly under the saddle.

Thus, according to a particular characteristic of the invention, the accommodation of the pivoting arm/rear wheel assembly under the saddle makes it possible to lock it in position by immobilizing under the saddle.

This characteristic gives the tilting of the saddle toward the front a dual function: increasing the compactness and forming a system for locking the pivoting arm in the folded-up position.

According to a preferential characteristic, the circular arcs described by the extreme point of the pivoting arm/rear wheel assembly and by the point under the saddle closest to the axis of rotation of the saddle uprights are non-concentric and such that the two circular arcs are tangential or secant at a point situated above the point of immobilization of the pivoting arm/rear wheel assembly by the saddle.

According to the principles of this characteristic of the invention, the two pivoting arm and saddle support entities are of substantially identical lengths and intersect but their pivoting orientations are different. The circles over which each is displaced in the opposite direction are not concentric, which makes it possible to provide a moment that is favorable to the intersection outside the moment of the intersection of the circles that they describe.

Apart from at this favorable moment, these two identities collide with one another and could not intersect. This characteristic makes it possible to provide an immobilization that is very easy to implement for the pivoting arm/rear wheel assembly under the saddle.

The relative displacements of the rear wheel and of the saddle over circles of radii that are similar and non-concentric allow for the rear end to be locked by the saddle in the folded-up position.

When the two entities intersect, the rear wheel is raised higher than its immobilizing position and, therefore, above the point of intersection of the two circles. By continuing its movement downward, and after having intersected the raised rear wheel, the saddle then partially engages in the internal opening of the frame to abut therein. There is then created an overthickness with the frame and/or the fairing which opposes an obstacle to the return of the wheel toward the ground when the latter descends again from its raised position above its immobilization position. The wheel is then immobilized in the raised position by the obstacle formed by the overthickness of the saddle on the frame or the fairing. The intersection of the circles described by the two blocks ensures that the rear wheel is jammed under the saddle when it drops back.

Advantageously, also, the saddle is fixed with mobility to the support of the saddle using an articulation enabling it to be raised via the front according to an axis of rotation related to its rear part or using a telescopic system enabling it to be raised so as to allow the rear wheel to pass before being folded down and to immobilize it.

This characteristic therefore gives a degree of freedom in rotation to the saddle in order, not only to allow or facilitate a passage of the rear wheel under the saddle by using circles of rotation that are as close as possible (maximum compactness), but also to allow the pivoting arm to be immobilized in the folded-up position. It will also advantageously include a housing in its front part able to favor the immobilizing of the wheel when lowered toward the front.

In a particularly simple embodiment, the saddle comprises a shell intended to be covered with the cushion of the saddle, this shell comprising a central opening in which the wheel will be housed.

Advantageously, the raising of the saddle is combined with the presence of the housing under the saddle. This makes it possible to form this housing and the shape of the saddle so that, without the raising of the saddle, the wheel could not access the housing because of the shape of the saddle which would then have a volume preventing the intersection with the rear wheel.

According to another advantageous characteristic of the invention, the vehicle comprises a system for locking the saddle upright in the unfolded position such that the rotation of the pivoting arm controls the locking/unlocking of the tilting of the saddle upright.

This characteristic makes it possible to simplify the folding up of the vehicle by ensuring that the movement of the saddle upright is possible provided that the pivoting arm has been driven in its movement toward the front and from the bottom and by immobilizing the movement of the saddle-supporting upright provided that the pivoting arm is brought toward the rear when unfolding. Thus, with this characteristic, the pivoting arm immobilizes the movement of the saddle when the vehicle is unfolded whereas, as seen previously, the saddle-supporting upright immobilizes the movement of the pivoting arm/rear wheel assembly when the vehicle is folded up. In a particular embodiment, the system for locking the saddle upright in position uses an abutment for the saddle-supporting upright and at least one lug fixed to the pivoting arm, sliding along a slideway in the form of a circular arc concentric to the rotation of the snug, formed in the saddle-supporting upright, the presence of the snug on this circular arc opposing the folding down toward the front of the saddle upright.

It will be noted here that the slideway may have one or two lateral sliding walls. In the case where it has only one sliding wall, it then advantageously consists of a simple relief in the form of a circular arc over which the snug slides. Such a relief is sufficient since the bearing pressure to be provided is exerted in a single direction. The snug fixed to the pivoting arm close to the axis of rotation pivots with the latter according to a circular arc whose center is the axis of rotation of the pivoting arm. In the unfolded vehicle position, this snug therefore slides in the slideway, for example by simply being applied to the relief in the form of a circular arc whose center is advantageously also the axis of rotation of the pivoting arm. The slideway is fixed to the saddle-supporting upright whose pivoting toward the front is performed according to a circular arc whose center is the pivot of rotation of this upright. For this embodiment, the pivot of the saddle upright is different from the axis of rotation of the pivoting arm, and preferentially positioned in front and above.

Thus, the snug pivots along the relief forming the slideway in the form of a circular arc or inside the slideway when the latter has two lateral walls. Since the slideway is supported by the saddle upright which itself pivots according to a different circular arc, the two circles intersect, therefore ensuring the opposition of the snug to the movement of the saddle upright.

Thus, if the saddle upright is stressed by pivoting toward the front, for example under the effect of braking, the surface of the relief forming the slideway or one of the walls of the slideway thus immediately abuts against the snug regardless of the movements of the pivoting arm in the deployed position. Thus, the snug, as long as it is positioned against the relief forming the slideway or inserted in the slideway, maintains the saddle upright in position.

Advantageously, the dimensioning of the slideway will be such that the snug is applied thereon or is inserted therein without play, when the pivoting arm is at the vertical and the saddle upright in position toward the rear, and therefore deployed. Thus, between the vertical and its extension toward the rear, the pivoting arm supporting the snug maintains the saddle in position. However, between the vertical and its extension toward the front, the pivoting arm releases the saddle upright which can thus tilt forward.

Such a positioning system situated in proximity to the axes of rotation about which the pivoting arm and the saddle-supporting upright are articulated, constitutes one of the useful means for allowing for the invention to be produced simply, compactly and robustly. It is in fact necessary for the saddle-supporting upright to be immobilized toward the rear of the vehicle so as not to tilt toward the front, for example when the user brakes. It is also useful for the pivoting arm to be securely attached to the saddle upright and to the frame, when it is deployed. The advantage of the positioning system as claimed is that it makes it possible to immobilize the two mobile elements in position with few operations and few movements. This embodiment requires the saddle upright to be unfolded before the pivoting arm can be placed in the deployed position.

According to another embodiment, the locking system for positioning the saddle upright uses an abutment for the saddle-supporting upright and at least one mobile part, for example a ball, supported by the frame engaging in and disengaging from an orifice provided in the saddle-supporting upright according to the deployment of the pivoting arm which supports a beveled cam structure to instigate the movements of the ball.

The ball is inserted into a tubular housing of the same diameter at the rear of the frame, located transversely. This housing is prolonged on the same axis, inside the saddle upright, by a tubular housing of smaller diameter so that the ball can engage therein in abutment but only partially and to a depth less than its diameter.

The cam is securely fixed to the pivoting arm and its beveled disk closes the housing of the ball. Depending on its bevel, and depending on the rotation of the pivoting arm, either the cam compresses the ball to the bottom of its housing where the ball is then positioned partly in the frame and partly in the saddle upright, preventing any movement of the latter, or it releases the ball which thus no longer prevents the movement of the saddle upright, which is then free to tilt forward.

Advantageously, a system for adjusting the position of the beveled disk of the cam makes it possible to adjust the compression that it applies to the ball, for example screws making it possible to position it at the appropriate distance from the ball.

This embodiment allows for a deployment of the vehicle that is more difficult, because it requires an adjustment, and therefore includes risks of maladjustment, of compression of the beveled cam on the ball. The relative positions of the elements in movement are therefore less rigorous than in the case where a slideway and a snug are used. Nevertheless, this embodiment does also allow for the simultaneous movements of the saddle-supporting upright and of the pivoting arm to unfold the cycle and lock the mobile elements in position. It also allows for the saddle-supporting upright to be fixed on the same axis of rotation as the pivoting arm, allowing for a more compact embodiment.

According to a particular characteristic of the invention, the pivoting arm comprises a damping system based on an elastic abutment between an element supported by the pivoting arm and an element supported by the saddle-supporting upright or the frame.

Such a damping system simply amounts to providing the pivoting arm with an elastic element that abuts on another abutment element supported by the saddle-supporting upright or the frame. Such an elastic abutment is advantageously produced with a buffer, for example made of rubber. This elastic abutment serves as a damper based on percussion or collapse. Since the pivoting arm is not attached to the frame by the damper, it is therefore free to pivot with a great amplitude.

Thus, advantageously, the damper of the pivoting arm is not linked to the frame. In fact, a pivoting arm is conventionally pre-angled between its axis of rotation fixed to the frame, the bearing of the wheel on the ground and the damper fixed between the pivoting arm and the frame. The set of these three points forms a triangle making it possible to hold the pivoting arm in position.

According to the invention, the pivoting arm is preferentially applied by compression to the frame at the location of the damper and there is no link opposing its resilience. This avoids, when folding up, having to detach any damper from the frame to allow the pivoting arm to pivot according to the movement provided for by the invention.

Nevertheless, it will be noted that it would be possible to envisage producing a damping system according to a different principle. In fact, the damper could be, for example, attached to the frame. In this case, it would be necessary to detach this damper from the pivoting arm in order to proceed with the folding up, which complicates the folding-up operation.

According to an advantageous characteristic, the pivoting arm comprises a stand-forming element making it possible to exert, by pressing on the rear of the vehicle, an upward force to pivot the pivoting arm/rear wheel assembly when the latter is pivoted to the front.

This characteristic makes it possible to easily raise upward, by downward pressure, the pivoting arm/rear wheel assembly folded up toward the front so as to allow for the passage of the saddle over the pivoting arm/rear wheel assembly. The use of a downward pressure to raise the rear end into the opening of the frame enables the user to exploit his weight via his foot.

### BRIEF DESCRIPTION OF THE DRAWINGS

Other features and advantages of the present invention will emerge from the following description, given with reference to the appended drawings which illustrate an example thereof that is in no way limiting.

In these figures:

FIG. 1 shows a perspective view of a cycle according to the invention;

FIGS. 2A to 2G describe the sequences for folding up a vehicle according to the invention;

FIG. 3 shows a preferential characteristic of the invention;

FIG. 4 shows an exemplary damping system that can be used in a vehicle according to the invention;

FIG. 5 shows the saddle notched to provide a housing for the rear wheel in the folded-up position;

FIGS. 6A to 6C show a first exemplary embodiment for the articulation elements making it possible to pivot the pivoting arm and tilt the saddle upright, these articulation elements also allowing for immobilization in position; and

FIG. 7 shows a second embodiment making it possible to fold and deploy the motorcycle vehicle according to the invention and immobilize it in position.

### DETAILED DESCRIPTION OF AN EMBODIMENT

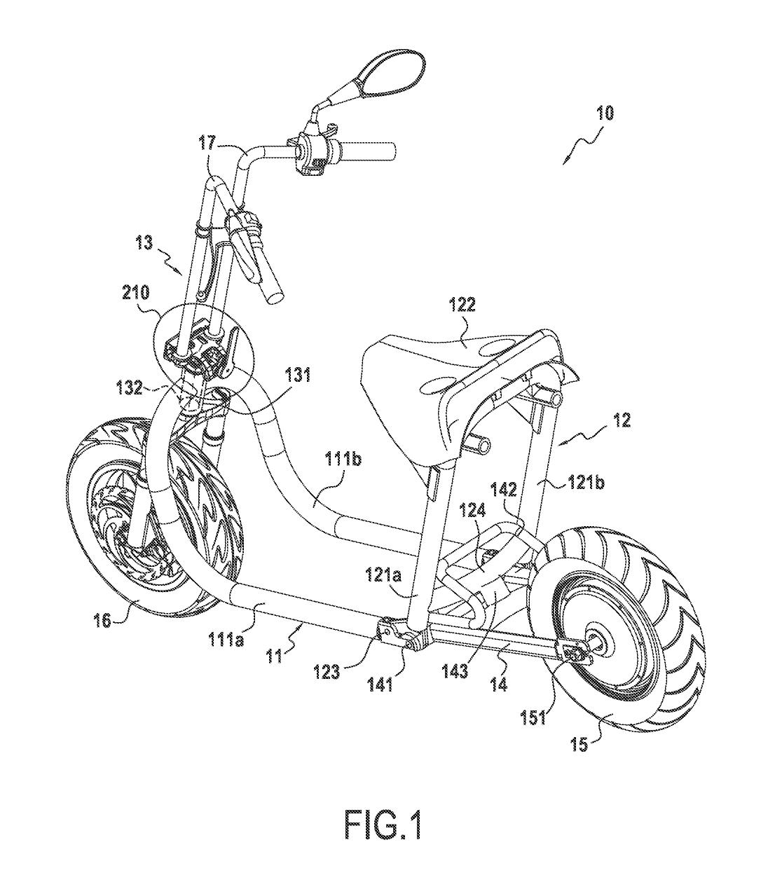

FIG. 1 represents a motorcycle vehicle 10 according to the invention comprising a frame 11 open in its middle.

Thus, as presented in FIG. 1, the frame 11 advantageously has a double-cradle configuration with the branches linked to two lateral bars 111a and 111b. The frame 11 supports a saddle-supporting upright 12 to support a saddle 122. The saddle-supporting upright consists of two lateral uprights 121a and 121b forming a fork under the saddle 122.

Mounted on this frame 11, about an axis of rotation 141, is a pivoting arm 14 supporting a rear wheel 15 mounted about an axis 151. Advantageously, the frame 11 has a floor likely to be opened or to be removed when the motorcycle vehicle is to be folded up. In the case where an electric motor is used, this floor will advantageously accommodate batteries.

On the front, the motorcycle vehicle 10 represented in the example of FIG. 1 has an articulated steering axis 13 engaged in a fork pivot 132 mounted in a steering tube 131 and supporting a front wheel 16. In its top part, the steering axis comprises a handlebar 17.

According to the invention, the pivoting arm 14/rear wheel 15 assembly is free to pivot toward the front of the vehicle 10 and from the bottom of the vehicle 10 about an axis of rotation 141 to be housed in the opening of the frame 11. The pivoting arm 14, and therefore the axis of rotation 141, will advantageously be fixed as far back as possible on the frame 11. In fact, the further back the pivoting arm 14 is fixed, the greater the unfolded length of the cycle 10. This unfolded length gives the vehicle its wheelbase.

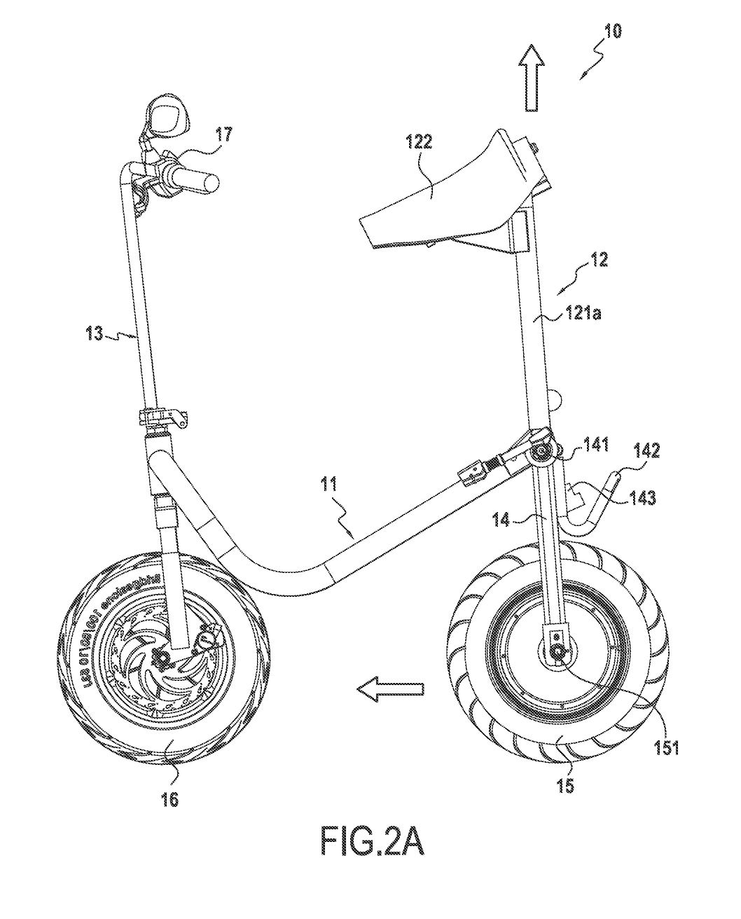

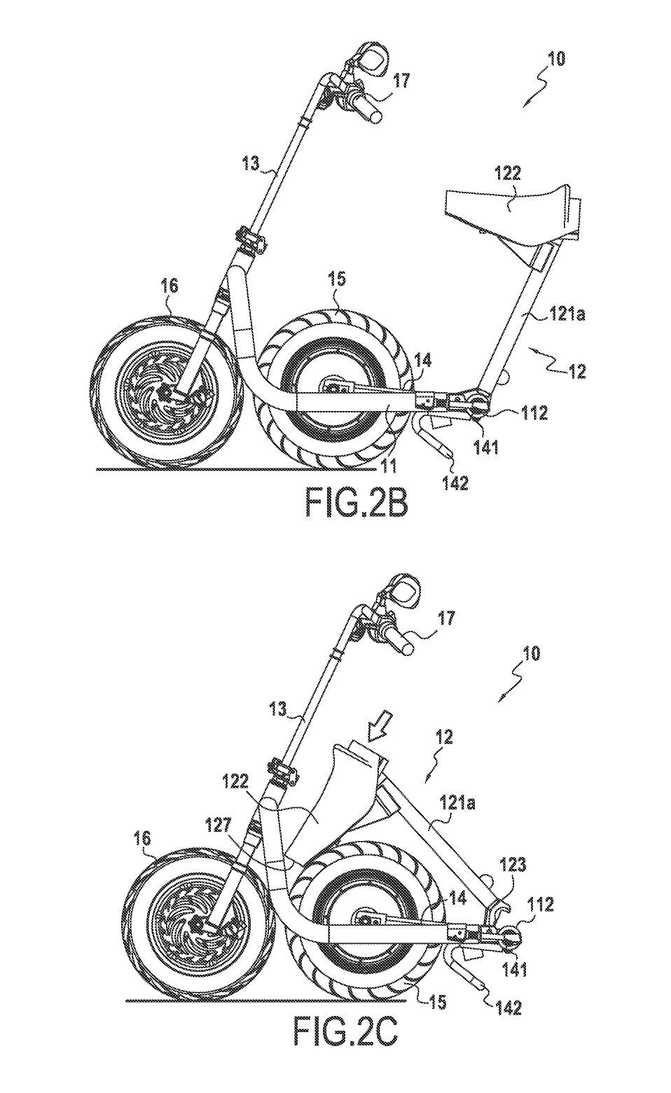

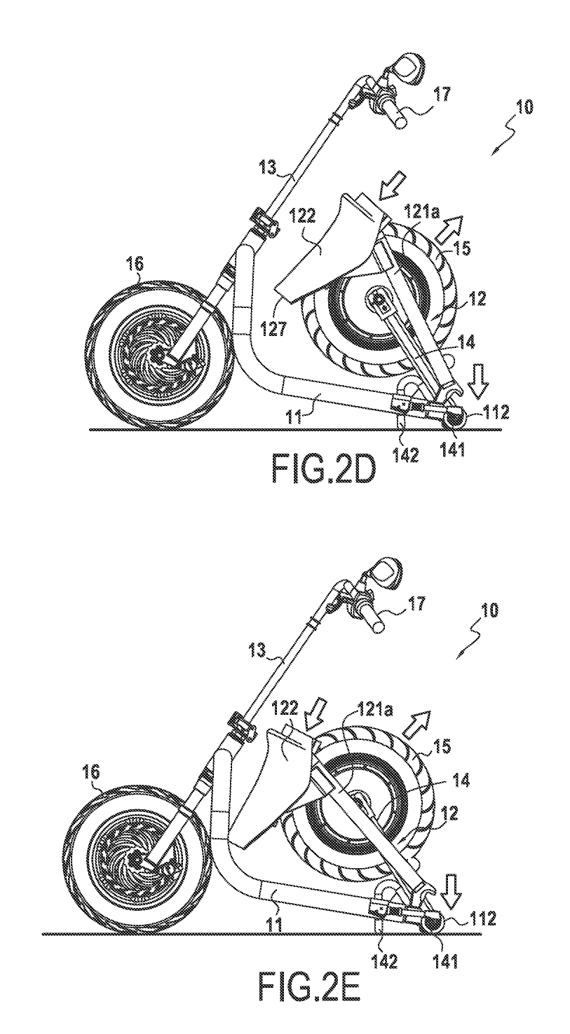

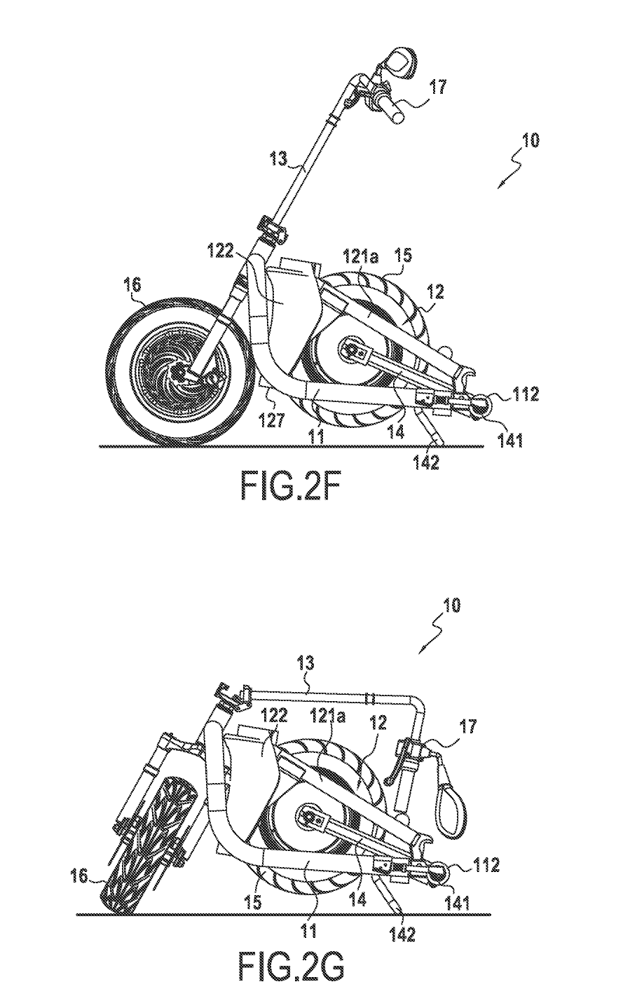

FIG. 2 shows the sequence for folding the cycle 10. In FIG. 2A, it is understood that the pivoting arm 14 is articulated about an axis of rotation 141 to an angle allowing the rear end consisting of the pivoting arm 14 with the rear wheel 15 to extend toward the front beyond the vertical of the axis of rotation 141.

It should be noted here that the invention particularly targets the motorcycle vehicles that are motor driven by an electric motor. Such a motor is usually installed within the rear wheel 15, which gives the latter a particularly significant weight compared to the rest of the vehicle 10. The resulting weight of the rear wheel 15 is an important advantage for the invention.

In fact, this characteristic ensures, as represented in FIG. 2A, that the rear wheel 15 remains in contact with the ground when the motorcycle vehicle 10 is raised by raising it at the back, for example by pulling the saddle 122 upward as illustrated by an upward arrow. By raising the rear of the motorcycle vehicle 10 sufficiently, it will thus be noted that the axis 151 of the rear wheel 15 will pass to the vertical of the axis 141 about which the rear end pivots as illustrated by the second arrow. Once the axis 151 of the wheel 15 has passed to the vertical of the point of axis of rotation 141 of the pivoting arm 14, it is sufficient to pull the frame 11 slightly toward the rear for the pivoting arm 14 to start inclining toward the interior of the frame 11.

The rear of the vehicle 10 duly raised, the pivoting arm 14 supporting the wheel 15 therefore passes from a horizontal position projected backward to a vertical position driving the wheel 15 rolling on the ground toward the front.

Past the point of inflection, the user can then release the vehicle for the frame 11 to return to the horizontal position as illustrated in FIG. 2B. In fact, once the vertical has been passed by the wheel 15, it is then sufficient to lower the rear of the motorcycle vehicle 10 again to then generate the continuation of the pivoting movement of the pivoting arm 14 toward the front of the cycle 10. The pivoting arm 14 then tends to resume a horizontal position, but projected in front of its axis of rotation 141 and no longer backward. The rear end is then housed within the opening of the frame 11. It is thus retracted. It will be observed that the speed of lifting facilitates passing the point of inflection.

In fact, rapid raising advances the rear wheel 15 toward the front. This then takes on a sufficient speed and itself passes the point of inflection. The releasing of the vehicle 10 ends the forcing of the rear wheel 15 toward the front. The wheel 15, and the pivoting arm, are then engaged in the opening of the frame 11. This rotational progress of the pivoting arm 14 is completed by the contact of a stand-forming element 142 on the ground. This stand 142 serves as a lever system and facilitates the raising of the wheel 15.

As represented in FIG. 2C, and according to a preferential characteristic of the invention, the saddle upright 12 is articulated about an axis 123 and is then folded down toward the front in a tilting movement, in a direction of rotation opposite to the rotation performed by the pivoting arm 14 as illustrated by the arrow. The saddle 122 then comes into contact with the rear wheel 15 according to a preferential embodiment of the invention.

According to a particular characteristic of the invention, the saddle 122 is supported by two lateral saddle-supporting uprights 121a and 121b, forming a fork under the saddle 122 and thus leaving a central opening under the saddle 122. The saddle support 122 is therefore advantageously in the form of a fork whose two lateral uprights 121a and 121b are positioned on either side of the frame 11 with a sufficient separation to allow the rear end to pass between them when folding up. The uprights 121a and 121b are therefore placed on either side of the wheel 15.

As can be seen in FIG. 2C, the movements of the saddle-supporting uprights and of the pivoting arm are prevented by the contact between these two structures.

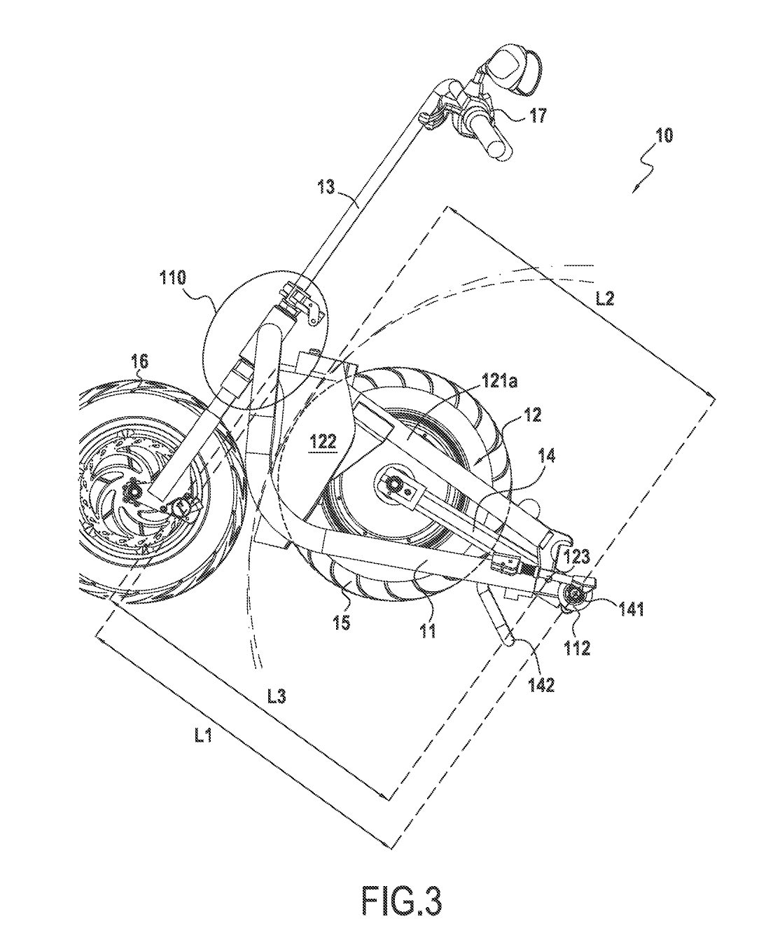

In fact, according to the invention, provision is made for the axes of rotation of the pivoting arm and of the saddle-supporting upright not to be the same. In this case, the circles over which the bottom of the saddle 122 and the most distant point of the rear wheel 15 are displaced are advantageously secant or tangent. The use of secant circles is illustrated in FIG. 3 and it can be clearly seen in this figure that this results in the presence of the immobilization point 127 of FIG. 2C. The circles described respectively by the point under the saddle, shown in dotted lines, and by the rear wheel, in chain-dotted lines, are in fact secant at two points. The intersection represented in FIGS. 2D and 2E is therefore possible only between the two points of intersection of these circles.

The system is further reinforced if the point of contact/immobilization 127 of the saddle with the wheel is mobile in the space by virtue, for example, of the raising of the saddle via a hinge in its rear part. Thus, this point 127 serves to lock the rear wheel by dropping toward the front, which is all the more effective when the pivoting radius of the front of the saddle is shorter than the pivoting radius of the wheel, the intersection of the saddle and of the wheel then being allowed by the raising of the saddle.

The passage beyond the lowest point of intersection, which is a point of immobilization, is obtained when the rear wheel/pivoting arm assembly is raised by virtue of the lever system provided by the stand 142. This is represented in FIG. 2D.

In this figure, the pivoting arm/rear wheel assembly is raised sufficiently above the ground to extend beyond the point of intersection, or, if appropriate, the point of tangency, of the two circles by exerting a sufficient downward pressure on the vehicle 11. At the level of the axis 141 of the pivoting arm 14, a lever effect is in fact obtained by pressing downward, according to the arrow, on the extension of the pivoting arm 14 making it possible to raise the wheel 15 with little force. The force is further reduced by the closeness to the ground of the point of application for the user and the pressure can be applied with the foot by mobilizing the weight of the body. This is all the more advantageous since the rear wheel 15 is generally heavy because it includes the motor. The saddle 122 is advantageously articulated on the uprights 121a and 121b so as to be raised upward by its front, as is represented in FIG. 2D, to pass over the rear wheel 15.

To intersect the saddle uprights 121a and 121b, the rear wheel 15 is raised further upward by virtue of a downward pressure using the stand element 142 as lever point. This is represented in FIGS. 2D and 2E. The relative movements of the saddle uprights and of the rear end illustrated by arrows then make them intersect. Once it has intersected the rear wheel 15, the saddle 122 is then folded downward and forward by its progressive application to the frame or the fairing, to come in front of the pivoting arm/rear wheel assembly. This assembly and the saddle upright supporting the saddle are then grouped together in a single block by virtue of the immobilization provided by the saddle 122 folded downward as represented in FIG. 2F.

To reduce the height of the folded-up vehicle, the saddle 122 is advantageously inserted into the frame 11 as represented in FIG. 2F. The pivoting arm/rear wheel assembly is then housed in the saddle 122 as represented in FIG. 2F. Because of the intersection of the circles represented in FIG. 3, the rear wheel 15 is then necessarily immobilized by the presence of the saddle 122, partially engaged in the opening of the frame 11. This immobilization is further reinforced by the folding down of the front end 127 of the saddle.

FIG. 3 shows a preferential characteristic of the invention according to which the extreme point of the pivoting arm 14/rear wheel 15 assembly describes a circular arc, shown as a chain-dotted line, not concentric with the circle described by the point under the saddle 122 closest to the axis of rotation of the saddle upright 12, shown as a dotted line. According to an advantageous characteristic of the invention, the two circles described by these two points are almost tangential or secant at a point situated slightly above the point of immobilization of the pivoting arm/rear wheel assembly, the saddle 122 being articulated so as to allow the rear wheel 15 to pass before the saddle is folded down to immobilize the wheel 15, by virtue of its end 127.

This almost intersection or intersection of the circles allows for the passage of the saddle 122 over the pivoting arm 14 and the rear wheel 15 while making it possible, once this point is passed, for the folding down of the saddle 122 to be able to ensure the immobilization of the pivoting arm/rear wheel assembly. It has been seen that, in its maximum folded-up position, the saddle 122 is lowered until its front end enters into the frame 11 and the fairing. Advantageously, in this movement, the saddle 122 and its upright intersect the pivoting arm/rear wheel 15 which then remains housed in the saddle 122 from above. It will then be observed that the saddle 122, in front of the frame 11, creates an overthickness on the frame 11 or the fairing which prevents the wheel 15 from crossing, in the reverse direction, the point of contact with the saddle 122.

The folded-down saddle then keeps the rear wheel 15 locked within it.

Advantageously, the folded-down saddle 122 is then held in position by the folding down of the handlebar over it, which prevents it from disengaging.

More specifically, in FIG. 3, it can be seen that the extreme point of the rear wheel 15 and the point under the saddle 122 on its support pivot in opposite directions, according to circles of similar but non-concentric radii and secant at least one point. These radii are dimensioned both to obtain a maximum length for the rear end contained by its insertion in the frame 11, and to obtain the appropriate height for the saddle 122 in the deployed position. Generally, this height is approximately 75 cm from the ground.

The chosen radius also makes it possible to insert the saddle 122 within the frame 11 at its front. Further-more, as seen previously, the radii allow the two assemblies to intersect at a moment that is favorable for ending their respective folding-down movement.

In FIG. 3, it will also be noted that the lengths L1, L2 and L3, respectively of the opening of the frame, of the fork formed by the saddle uprights and of the pivoting arm/rear wheel assembly, are advantageously three comparable lengths. These length similarities thus ensure that the maximum compactness once the vehicle is folded up is achieved.

When stating that the three parts which are the frame, the rear end and the saddle on its support must be of equal lengths, it will be noted that the basic datum is the length of the frame. Once the length of the frame 11 is set, the lengths of the rear end and of the saddle support with the saddle will then be determined according to the principles of compactness stated above.

This almost identical dimensioning makes it possible to maximize the deployed length/folded-up length ratio. In fact, any additional centimeter saved in internal length of the frame is reflected in a centimeter saved in length of the rear end and therefore in overall wheelbase length after deployment. It should be stressed that the maximum length of the deployed frame is then a function of the folded-up dimension sought according to the principle of the invention. It in fact conditions the length of the rear end since the latter is housed inside the frame and the length of the saddle and saddle support assembly since the latter intersects the rear end by passing above when folding up.

It should be noted that the saddle and saddle support assembly is limited in elongation to provide the seat height on the vehicle and to be inserted within the frame in the folded-up position. Now, it happens that the seat height requirements are quite compatible with the use of substantially equal lengths for the frame, the rear end and the saddle on its support.

To maximize the length of the frame 11 for a given overall folded-up length, the frame 11 is designed according to the invention with a form open in its middle. This form may be a rectangle, a U-shape, a J-shape as long as this opening provides a suitable width and above all a suitable length to accommodate, within it, the assembly comprising the rear wheel 15 and its pivoting arm 14 when folding up.

Advantageously, the frame 11 will be implanted obliquely, the front being uppermost. The greater the angle of obliqueness, the more internal length is offered by the frame 11 to accommodate the pivoting arm 14/rear wheel 15 assembly, while observing the possible length in the horizontal plane. For example, an oblique inclination of 10 to 15 degrees makes it possible to obtain the result according to the invention without resulting in an exaggerated increase in the overall thickness of the frame 11.

Thus, for a frame with a length in the horizontal plane of 640 mm, an inclination of 10 degrees makes it possible to produce an oblique frame of 650 mm. The 10 mm gained in this way allows for a corresponding elongation of the elongated pivoting arm/rear wheel assembly in the frame when folding up.

An interesting alternative is for the frame 11 to provide an oblique internal shape for the assembly comprising the rear wheel 15 and its pivoting arm 14 during folding up even though it is overall horizontal. This alternative assumes an optimum form if the frame adopts a double-cradle configuration with the branches fixed to the steering tube, because the oblique is maximized, rising toward the steering tube.

The frame 11 being of a thickness less than the diameter of the wheel 15 that it accommodates, it is then topped by an opening or removable platform in order to accommodate the rear wheel within it.

The function of this platform is to accommodate the feet of the driver. In opening configuration, it is opened, when folding up, to allow the rear wheel 15 to pass when said wheel is inserted into the frame 11. In removable configuration, it is no longer applied to the frame 11 and therefore completely frees up the space.

Possibly, the rear end may be further elongated beyond the internal length of the frame 11 which constitutes the basic datum and, beyond the height of the saddle and its support by the use of the flexible material deformation capability. It will, for example, be increased by a length equal to the collapsing capability of the tire on the frame 11 to pass under force, this length being, for example, equal to 10 mm.

In order to allow for the intersection with the saddle 122, said saddle is advantageously greatly thinned in its bottom central part, so as to free up a passage for the wheel 15. At this point, it will advantageously consist of a flexible material whose deformation correspondingly increases the length of the rear end.

In FIG. 2G, the motorcycle vehicle 10 is entirely folded up, the handlebar tube 17 being brought back onto the folded up cycle 11. To unlock the wheel 15 as represented in FIG. 2G, the reverse operation is performed by pressing on the pivoting arm on the rear of the vehicle 10; a lever action is applied to the stand 142, which raises the folded-up wheel 15, thus releasing the saddle 122.

Once the saddle 122 is straightened up, the rear wheel 15 is released and drops back into contact with the ground. It is then sufficient to raise the vehicle by the saddle in the same way as when folding up. The rear wheel is then projected toward the rear. Past the point of inflection, all that is needed is to lower the vehicle which is then in the deployed position.

It should be noted that any other system for locking the pivoting arm/rear wheel assembly in position could be adopted such as keyways, indexing fingers, hooks, locks, etc. The saddle 122 is then folded down and held in position but with no specific function for locking the pivoting arm/rear wheel assembly. However, these implementations will generally be more complex to handle.

In FIGS. 1 and 2, it can be seen that the pivoting arm 14 comprises an elastic abutment 143, the function of which is to strike on a crossmember 124 of the saddle upright 12 and provide a damping role thereon.

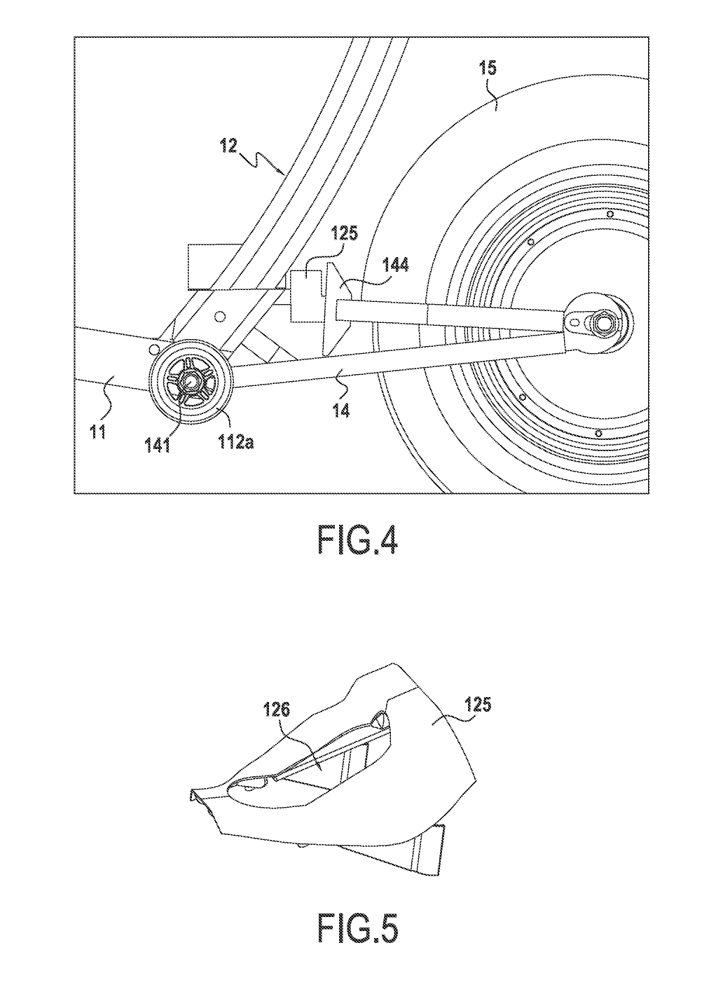

FIG. 4 shows a variant embodiment in which an elastic buffer 125 is supported by the saddle upright 12 and an abutment plate, denoted 144, supported by the pivoting arm 14, abuts against this buffer 125 when the pivoting arm 14 is deployed.

In this figure, the presence will also be noted of a small lateral wheel 112a which is mirrored on the other side of the cycle 10 and which is useful for rolling the motorcycle vehicle 10 as necessary once folded up. FIG. 5 shows an example of a shell 125 of a saddle 122 suitable for the invention. This shell 125 is intended to be covered with foam. It comprises a central opening 126 in which will be housed the rear wheel 15 portion in the manner represented in FIG. 2F.

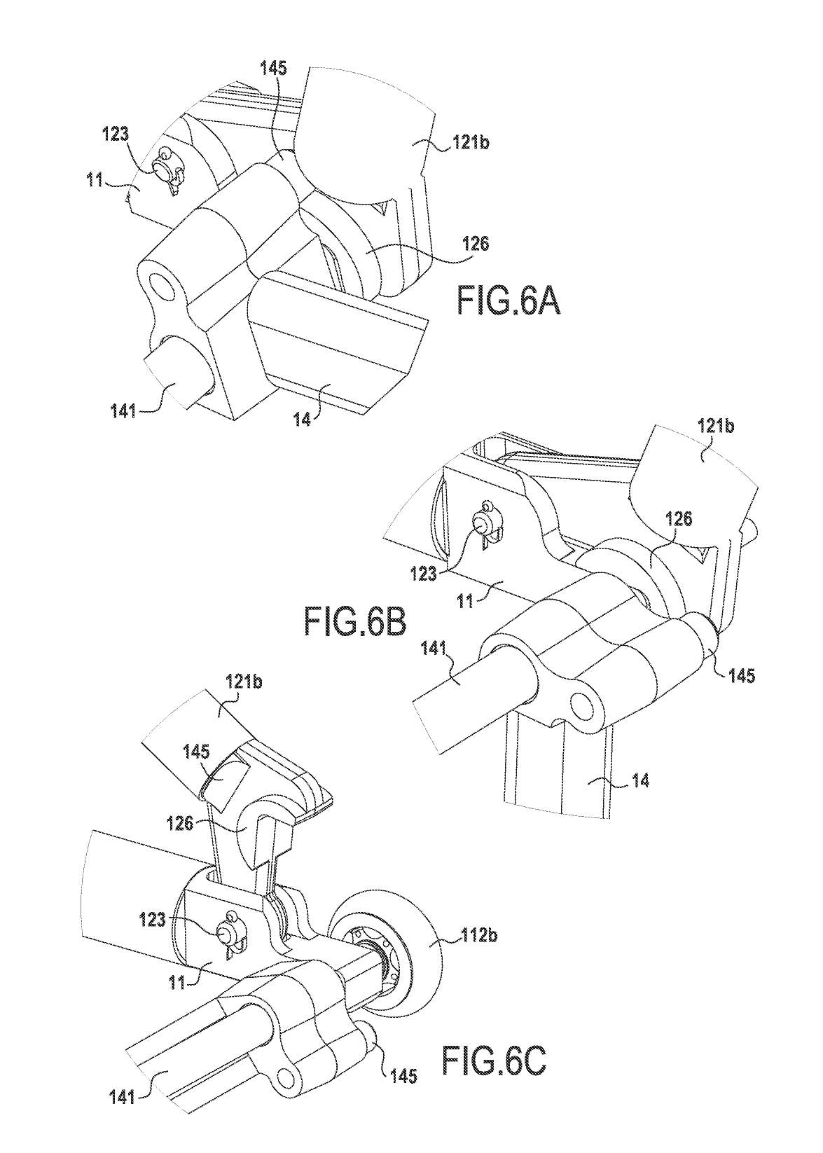

FIG. 6 represents in detail the articulations about the axes 141 and 123. The enlarged perspective view represented in FIG. 6 corresponds to the right side of the vehicle 10 represented in FIGS. 1 and 2 at the level of the frame/pivoting arm link. This figure shows a first embodiment for positioning and securing the pivoting arm/rear wheel and saddle upright assembly.

In FIG. 6, it will be noted that the saddle upright 121b is, in its deployed configuration, bearing with the rear overhang on the frame 11. The frame 11 comprises for this an open vertical housing to accommodate the base of the saddle support 12 when the latter is deployed. The saddle support 12 is engaged in the vertical housing when the saddle is deployed and is disengaged therefrom when the saddle 122 is folded up by pivoting about the axis of rotation situated in front of the housing.

The pivoting arm 14, articulated about the axis 141, is partially represented. According to an advantageous embodiment of the invention, the pivoting arm 14 comprises a snug 145 which will slide in a slideway which here is defined by a relief 126 along which the snug 145 slides over the lateral upright 121b of the saddle upright 12 which is also partially represented.

In the embodiment of FIG. 6, the slideway 126 is thus a slideway with a single face, and open. The bearing of the snug 145 on the face 126 is in fact sufficient for the movement of the saddle upright 121b toward the front to be prevented when the pivoting arm 14 is deployed as is presented in FIG. 6A.

It is nevertheless quite possible to envisage the snug 145 sliding in a slideway with two hollowed-out lateral faces in the saddle upright 121b. The embodiment with a single face does, however, make it possible to use a larger snug 145 which gives the assembly a better robustness.

It can be clearly seen, in FIG. 6, that the saddle upright 121b is articulated about the axis 123 which is situated in proximity to the axis 141 but which is not the same as the latter. The axis 123 is in fact slightly forward and above the axis 141 about which the pivoting arm 14 is articulated.

This ensures the preferential characteristics represented in FIG. 3, according to which the circular arc described by a point below the saddle 122, represented by a dotted line, has a radius less than the latter, represented as a chain dotted line, described by the pivoting arm 14 and the rear wheel 15, while ensuring that these circles are secant or tangent.

In FIG. 6B, which corresponds to the folding-up/unfolding step of FIG. 2A, it can be seen that the snug 145 is rotationally displaced by sliding over the slideway surface 126. It will be noted that now, the position of the snug 145 no longer makes it possible to prevent the movement of the saddle upright 121b articulated about the axis 123, to tilt toward the front. The saddle upright 121b is then released and free to pivot about the axis 123 toward the front of the cycle.

In FIG. 6C, the pivoting arm 14 is brought to the front of the cycle and it can be seen that the saddle upright 121b is still released despite its deployed position.

In FIG. 6D, it can be seen that the pivoting arm 14 is brought to the front of the cycle and that the saddle upright 121b is also tilted to the front after its disengagement from the snug 145.

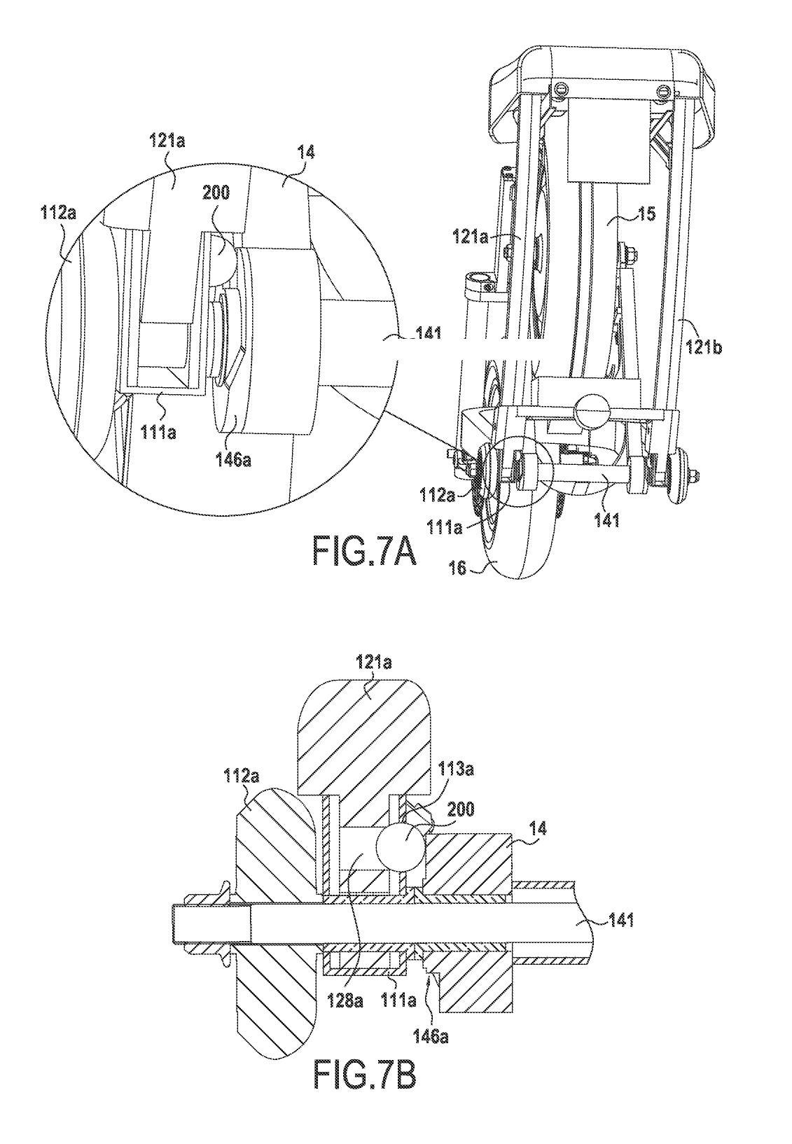

FIG. 7 shows another embodiment for the immobilization between pivoting and tilting elements, this time on the left side of the cycle and with the pivoting arm 14 brought to the front. According to this embodiment, a ball 200 is then successively pressed into, in FIG. 7B, or released from, in FIG. 7A, a cavity 128a provided for this purpose on the saddle upright 121a by virtue of a beveled cam-shaped surface 146a and through an orifice 113a formed in the bar 111a of the frame 11.

The cam-forming surface 146a is a beveled rotary disk, concentrically and securely fixed to the pivoting arm 14. This rotary disk accompanies the pivoting arm 14 in its rotation, in a plane close to the frame 11, for example at a few millimeters. This disk may be a few centimeters thick. In the plane of its slice, it is partly beveled, each of the two lateral ends of the pivoting arm is equipped therewith.

When the pivoting arm 14 is pivoted toward the front by raising the saddle 122, as represented in FIG. 7A, the cam 146a is placed so that the ball 200 is disengaged from the cavity 128a provided in the saddle upright 121a, then allowing the saddle and the saddle upright 121a to be tilted toward the front.

On the other hand, when the pivoting arm 14 is brought toward the rear, as represented in FIG. 7B, the cam 146a presses on the ball 200 which, through the orifice 113a formed in the bar 111a, becomes housed in the cavity 128a of the saddle upright 121a. The forward movement of the saddle upright 121a is then prevented.

In other words, the frame 11 comprises two transversal and horizontal, open and symmetrical orifices 113a and 113b, each opening into a cavity, respectively 128a and 128b in the saddle-supporting uprights 121a and 121b and, on the other hand, on the internal face of the frame 11, each facing a rotary disk, respectively 146a and 146b, fixed on the pivoting arm 14.

The transversal and horizontal orifices 113a and 113b each contain a mobile part 200 which is usually a ball. The length of the transversal and horizontal orifices through the elements 111a and 111b of the frame 11 is less than the length of the mobile part 200 so that a part of the latter is always protruding on one side or the other of the orifice. Thus, if it accommodates a ball of 15 mm diameter, its length will be less than 15 mm.

The mobile part 200 is positioned in the orifice and guided for a displacement between the internal face of the frame 11 and the cavity in the saddle support. This part 200 is in contact with the beveled face of the rotary disk.

Depending on the thickness of the bevel, it is more or less constrained toward the interior of the cavity formed in the saddle support. The base of the saddle-supporting uprights engaged in the vertical housing have cavities 128a and 128b which are in the extension of the transversal orifice of the mobile part 200.

The opening of these cavities is suited to the size of the mobile part 200 so as to allow it to penetrate only partially. For example, it may be tubular, hollow semi-spherical and with a diameter less than that of the ball 200 so as to allow the latter to penetrate partially.

When the rotary disk 146a exerts a progressive pressure by virtue of its beveled shape as it is pivoted on the mobile part 200, the latter is then displaced transversely. The ball 200 that is pushed in this way partially exits from the other side and penetrates as abutment into the cavity. It then prevents any movement of the saddle-supporting upright 121a. Thus, on each side of the cycle, the movement of the saddle-supporting upright is prevented.

In the position of the pivoting arm 14 between the vertical and the extension toward the rear, the mobile parts 200 are constrained by the beveled disks 146a and 146b to be partly inserted into the cavities 128a and 128b. They then securely attach the saddle support 12 to the frame 11.

In the position of the pivoting arm 14 between the vertical and the extension toward the front, the beveled disks 146a and 146b release the mobile parts 200 which no longer hamper the movement of the duly released saddle support 12. The saddle 122 becomes mobile again to be folded up.

According to this device, just the movement of raising the vehicle initiates the pivoting of the pivoting arm 14 to the vertical and releases the locking of the saddle 122. On the other hand, the releasing of the vehicle that accompanies the pivoting of the pivoting arm 14 toward the rear, ensures the concomitant locking of the saddle 122, which simplifies the procedures.

The embodiment of FIG. 7 makes it possible to lock the movement of the saddle 122 and of the saddle support 12 in a single movement. It also makes it possible to use one and the same axis of rotation for the pivoting arm/rear wheel assembly and for the saddle uprights. However, by using one and the same axis of rotation, the use of non-concentric circles is compromised for immobilizing the wheel with the saddle. It is then necessary for the saddle to be articulated to be raised upward and thus allow the pivoting arm/rear wheel assembly to pass.

It should be noted here that, even if it allows for a particularly advantageous embodiment of the invention, the articulation of the saddle is not necessary, even if advantageous, in the case where non-concentric circles are used and, therefore, where two axes of rotation are used. In practice, in this case, the saddle may be fixed provided that the rear wheel can rise high enough to sufficiently extend beyond the point of intersection and allow for intersection with the saddle uprights.

The embodiments presented in FIGS. 6 and 7 provide a locking and an unlocking of the folding up and of the unfolding of the saddle and of the rear wheel by operations that are particularly easy to carry out.

In practice, the rotation of the pivoting arm controls the locking/unlocking of the saddle uprights, with no other operation. Thus, in a single action, the rear end is tilted toward the front and the saddle will be locked or unlocked.

According to the invention, not only the movement of the saddle toward the front makes it possible to immobilize the pivoting arm/rear wheel assembly in the folded position, but also the movement of the pivoting arm toward the unfolded position makes it possible to immobilize the movement of the saddle toward the front in the unfolded position of the cycle.

The two folding/unfolding movements are therefore doubly functional according to the preferential embodiments of the invention.

It will finally be noted that the subject of the invention will advantageously be used in combination with an articulation device that allows for a folding up of the handlebar on the axis of the cycle. In this case, it is possible to envisage, advantageously and originally, a folding down of the front wheel to the side of the cycle in order to reduce the folded-up length of the cycle subsequent to or concomitant with the folding up of the steering axis on the axis of the cycle. In such a case, it will be advantageous for the front fork to be dissymetrical, in this case single-tube, so as to free up a maximum of space for folding up the rear end of the cycle according to the invention between the branches of the double-cradle frame.

In fact, as can be seen in FIG. 2G, the fork may constitute an obstacle to the folding up toward the front of the rear end or to the tilting of the saddle. It may in fact abut against the saddle during folding up. In this case, it is necessary to shorten the length of the saddle uprights and, also, a priori, that of the rear end. This goes against the principles of the invention which is to obtain a vehicle that is as long as possible once unfolded and as short as possible once folded.

It will be understood here that the use of a single-tube fork makes it possible to exploit to the maximum the space toward the front between the branches of the double-cradle frame. It is then possible to further elongate the saddle upright and therefore also the rear end, which is perfectly desirable in pursuing the aims of the invention.

It will finally be noted that various implementations can be produced according to the principles of the invention.

1. A motorcycle vehicle comprising a frame open in its middle and supporting at least one saddle-supporting upright to support a saddle, on which frame is mounted, about an axis of rotation, a pivoting arm supporting a rear wheel, characterized in that the pivoting arm/rear wheel assembly is free to pivot toward the front of the vehicle and via the bottom of the vehicle about its axis of rotation so that it can be housed in the opening in the frame.

2. The motorcycle vehicle as claimed in claim 1, characterized in that the pivoting arm/rear wheel assembly is free to pivot toward the front of the vehicle and via the bottom over an angle greater than 180°.

3. The motorcycle vehicle as claimed in claim 1, characterized in that the frame comprises a double cradle whose branches are connected to the steering tube vertically or obliquely, each of these branches also being connected to a lateral bar, the space between the branches of the double cradle and the lateral bars defining the internal opening of the frame.

4. The motorcycle vehicle as claimed in claim 1, characterized in that the maximum length of the internal opening of the frame and the pivoting arm/rear wheel assembly have almost identical lengths.

5. The motorcycle vehicle as claimed in claim 1, characterized in that the saddle-supporting upright is articulated about an axis of rotation which is situated close to or is the same as the axis of rotation of the pivoting arm, this saddle-supporting upright being able to tilt toward the front of the vehicle and via the top of the cycle so as to join, above the frame of the cycle, the pivoting arm/rear wheel assembly when the latter is pivoted toward the front of the vehicle.

6. The motorcycle vehicle as claimed in claim 5, characterized in that the maximum length of the internal opening of the frame, the pivoting arm/rear wheel assembly and the saddle-supporting upright have substantially identical lengths.

7. The motorcycle vehicle as claimed in claim 5, characterized in that the saddle tilted toward the front makes it possible to lock the pivoting arm/rear wheel assembly in the folded-up position.

8. The motorcycle vehicle as claimed in claim 5, characterized in that the saddle-supporting upright is such that the pivoting arm/rear wheel assembly pivoted toward the front is accommodated under the saddle.

9. The motorcycle vehicle as claimed in claim 7, characterized in that the accommodation of the pivoting arm/rear wheel assembly under the saddle makes it possible to lock it in position by immobilizing under the saddle.

10. The motorcycle vehicle as claimed in claim 5, characterized in that the circular arcs described by the extreme point of the pivoting arm/rear wheel assembly and the point under the saddle closest to the axis of rotation of the saddle uprights are non-concentric and such that the two circular arcs are tangential or secant at a point situated above the point of immobilization of the pivoting arm/rear wheel assembly by the saddle.

11. The motorcycle vehicle as claimed in claim 5, characterized in that the saddle is fixed with mobility to the support of the saddle using an articulation enabling it to be raised via the front according to an axis of rotation related to its rear part or using a telescopic system enabling it to be raised so as to allow the rear wheel to pass before being folded down and to immobilize it.

12. The motorcycle vehicle as claimed in claim 5, characterized in that it comprises a system for locking the saddle upright in the unfolded position such that the rotation of the pivoting arm controls the locking/unlocking of the tilting of the saddle upright.

13. The motorcycle vehicle as claimed in claim 12, characterized in that the system for locking the saddle upright in position uses an abutment for the saddle-supporting upright and at least one snug fixed to the pivoting arm, sliding into a slideway in the form of a circular arc concentric to the rotation of the snug, formed in the saddle-supporting upright, the presence of the snug on this circular arc opposing the folding down toward the front of the saddle upright.

14. The motorcycle vehicle as claimed in claim 12, characterized in that the locking system for positioning the saddle upright uses an abutment for the saddle-supporting upright and at least one mobile part supported by the frame engaging in and disengaging from an orifice provided in the saddle-supporting upright according to the deployment of the pivoting arm which supports a beveled cam structure to instigate the movements of the mobile part.

15. The motorcycle vehicle as claimed in claim 1, characterized in that the pivoting arm comprises a damping system based on an elastic abutment between an element supported by the pivoting arm and an element supported by the saddle-supporting upright or the frame.

16. The motorcycle vehicle as claimed in claim 1, characterized in that the pivoting arm includes a stand-forming element that makes it possible to exert, by pressing on the rear of the vehicle, an upward force to pivot the pivoting arm/rear wheel assembly and raise it above the ground when the latter is pivoted to the front.
